(19) United States
(12) Patent Application Publication
(10) Pub. No.: US 2006/0161500 A1
(43) Pub. Date: Jul. 20, 2006

(54) Method and system for coordinating banking and sports league support

(75) Inventor: Andrew Franzone, New York, NY (US)

Correspondence Address: MILBANK, TWEED, HADLEY & MCCLOY, 1 CHASE MANHATTAN PLAZA, NEW YORK, NY, 10005-1413, US

(73) Assignee: Andrew T. Franzone, LLC

(21) Appl. No.: 11/331,678

(22) Filed: Jan. 13, 2006

Related U.S. Application Data
(60) Provisional application No. 60/644,906, filed on Jan. 19, 2005.

(51) Int. Cl. G06Q 40/00

(52) U.S. Cl. 705/43

(57) ABSTRACT

A customer provides funds for a banking process with sports league support. The banking process provides direct and indirect payment of funds to entities in the sports league, including a league sanctioning body, participants, non-league related recipients, owners affiliated with the league and league entities, sponsors affiliated with the league and league entities, indirect sources, and in some cases, customers and banks. The banking process also supports the linkage of indirect fund sources to the system.

This application claims priority to U.S. Provisional Patent application Ser. No. 60/644,906, filed Jan. 19, 2005, entitled METHOD AND SYSTEM FOR COORDINATING BANKING AND SPORTS LEAGUE SUPPORT, the disclosure of which is incorporated herein by reference.

### BACKGROUND

1. Field of the Invention

The invention relates to the field of banking and more particularly to the field of banking with support of sports leagues.

2. Description of the Related Art

Deposit vehicles, and more particularly savings accounts, checking accounts, and certificates of deposit (CDs) are known in the art. Similarly, sports leagues with league sanctioning bodies, participants, and sponsors of the participants and league are also known in the art. It is also known for banking companies to sponsor sports entities in return for name placement in advertising. What is needed are systems and methods for combining aspects of traditional banking and sports league support, where these systems and methods provide direct and indirect payment of funds to the entities of the sports league, as well as support the linkage of indirect fund sources to the system.

The preceding description is not to be construed as an admission that any of the description is prior art relative to the present invention.

### SUMMARY OF THE INVENTION

In one embodiment, the invention provides a method and system for banking and sports league support. The method and system comprises receiving funds; managing the funds for banking purposes; determining a value of banking management activity; determining a pool value; providing the banking management value to a banking manager; and providing the pool value to at least one entity in a sports league.

In a further embodiment, the invention further comprises providing the pool value from the managed funds. In a further embodiment, the invention comprises providing the pool value from the received funds. In a further embodiment, the invention comprises providing the banking management value from the managed funds. In a further embodiment, receiving funds comprises receiving funds from a customer.

In a further embodiment, receiving funds comprises receiving funds from an indirect source. In a further embodiment, the indirect source is a rewards program. In a further embodiment, the indirect source is a rebate program. In a further embodiment, the indirect source is a participating product or service program. In a further embodiment, the indirect source is a matching payment program. In a further embodiment, the indirect source is a purchase incentives program, where the purchase incentives include discount, rebate, credit, rewards, points, and matching payment programs. In a further embodiment, the indirect source is linked to a customer.

In a further embodiment, determining a pool value considers whether the managed funds satisfied banking objectives.

In a further embodiment, the entity in a sports league is a league sanctioning body. In a further embodiment, the entity in a sports league is a league sponsor. In a further embodiment, the entity in a sports league is a participant sponsor. In a further embodiment, the entity in a sports league is a participant. In a further embodiment, the entity in a sports league is an indirect source. In a further embodiment, the entity in a sports league is a non-league related recipient. In a further embodiment, the entity in a sports league is a league owner. In a further embodiment, the entity in a sports league is a participant owner.

In a further embodiment, providing the pool value further comprises selecting at least one entity in a sports league; and providing the pool value to the selected entity. In a further embodiment, the funds are received from a customer and the customer selects the entity. In a further embodiment, providing the pool value comprises providing the pool value to a customer and at least one entity in a sports league. In a further embodiment, providing the pool value comprises providing the pool value to a banking manager and at least one entity in a sports league.

The specific objects and advantages of the invention described herein are illustrative of those which can be achieved by the present invention and are not intended to be exhaustive or limiting of the possible advantages that can be realized. Thus, the objects and advantages of this invention will be apparent from the description herein or can be learned from practicing the invention, both as embodied herein or as modified in view of any variations which may be apparent to those skilled in the art. Accordingly, the present invention resides in the novel parts, constructions, arrangements, combinations and improvements herein shown and described.

### BRIEF DESCRIPTION OF THE DRAWINGS

The features and other aspects of the invention are explained in the following description taken in conjunction with the accompanying figures wherein:

FIG. 1 illustrates a system according to an embodiment of the invention;

FIG. 2 illustrates steps in a method according to the prior art;

FIG. 3 illustrates steps in a method according to an embodiment of the invention;

FIG. 4 illustrates steps in a method according to an embodiment of the invention;

FIG. 5 illustrates steps in a method according to an embodiment of the invention;

FIG. 6 illustrates steps in a method according to an embodiment of the invention;

FIG. 7 illustrates steps in a method according to an embodiment of the invention;

FIG. 8 illustrates steps in a method according to an embodiment of the invention; and

FIG. 9 illustrates steps in a method according to an embodiment of the invention.

It is understood that the drawings are for illustration only and are not limiting.

### DETAILED DESCRIPTION OF THE DRAWINGS

In the various embodiments described below, the system and method of the invention provide an opportunity for participation in a banking process where banking is also loosely coupled to supporting sports leagues and entities in the sports leagues. In one embodiment a customer chooses to join the banking process with league support. The customer then provides funds to the banking process. As with most banking processes, the customer chooses a specific deposit product in which to place his funds, and a management fee or cost is associated with his banking activities. That fee or cost is typically deducted from the proceeds in the customer's deposit account, and then that fee or cost is paid to the bank managing the funds. In the invention, a portion of the management fee or cost is allocated to a post-banking pool. The post-banking pool is available for allocation to entities of a sports league. The sports league entities include a league sanctioning body, league participants, sponsors affiliated with a league and league entities, indirect sources, non-league related recipients, and owners affiliated with a league and league entities. In certain circumstances, league entities also include customers and the banks.

In another embodiment, a portion of the funds that have entered the banking process are diverted before they are placed in deposit vehicles. These diverted funds are allocated directly to league entities who then receive these allocated funds in this pre-banking direct allocation.

In another embodiment, a portion of the funds that have entered the banking process are diverted before they are placed in deposit vehicles. These diverted funds are allocated to a pre-banking pool. The pre-banking pool is allocated to specific league entities who then receive funds from this pre-banking pool.

In another embodiment, funds enter the banking process through indirect sources of capital. These indirect sources of capital create indirect fund flows which enter the banking process. Once part of the banking process, then all or some of the indirect flows may be applied to the deposit vehicles, or all or some of the indirect flows may be diverted before they reach these deposit vehicles, and applied to the pre-banking pool or the pre-banking direct allocation process. Indirect flows as well as indirect sources of capital are discussed further below.

In some of these embodiments, the customer makes the allocation to a particular sports league entity. In other embodiments, the system or specific entities of the system makes the allocation.

Further details and descriptions of these and other embodiments are provided below.

### AN EXAMPLE SYSTEM

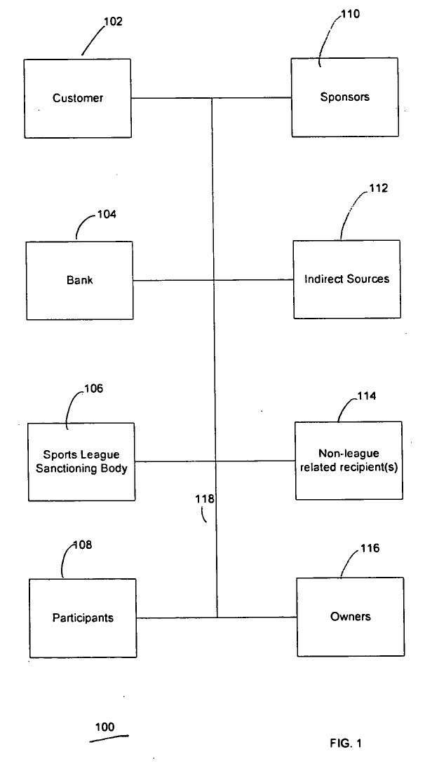

Referring to FIG. 1, an example of one embodiment of system 100 according to the invention includes customer 102, bank 104, sports league sanctioning body 106, participants 108, sponsors 110, indirect sources 112, non-league related recipients 114, and owners 116. Some or all of customer 102, bank 104, sports league sanctioning body 106, participants 108, sponsors 110, indirect sources 112, non-league related recipients 114, and owners 116 have or use computers with central processors, volatile and non-volatile memory, input/output devices, fixed and removable software code storage media, display devices and network connection devices. The individual network connection devices with network 118 provide a wired or wireless connection among customer 102, bank 104, sports league sanctioning body 106, participants 108, sponsors 110, indirect sources 112, non-league related recipients 114, and owners 116.

Customer 102 is an entity with funds in its possession, and may include a person or an entity with a particular league affiliation, or with no particular league affiliation. Bank 104 is intended to be a broad term, and examples include traditional retail banks, as well as other financial entities who may operate or manage deposit products, including, but not limited to, consumer finance firms, commercial banks, savings banks, credit unions, investment banks, brokerage firms, and mortgage companies. Bank 104 may also include any other financial entities which can coordinate banking with sports league support. Bank 104 may be a financial division of a sports league sanctioning body, a sports league sponsor, an entity in system 100, or a non-league entity. Bank 104 may also be a part of a consortium of league entities or non-league entities. League sanctioning body 106 may include sporting event coordinators, owners, rule-makers, commissioning bodies, organizers, and promoters. Participant 108 may be an individual participant, or it may be a team or syndicate of many individuals who participate as one group in a sports competition. Sponsors 110 may be sponsors of participants, the league, league facilities, league venues, league media partners, or any other entities or people related to a sports league. Indirect sources 112 may include incentives for products and services that are generally related to system 100; indirect sources 112 may also include various sources of capital for the banking process, where these sources of capital are not directly linked to an banking decision made by customer 102. Non-league related recipients 114 may include entities such as charities, non-profit enterprises, political groups, religious groups, special interest groups, league marketing campaigns, league media partners, league affiliates, league business partners, and league construction projects. Owners 116 may be owners of participants, the league, league facilities, league venues, league media arrangements, and other entities generally related to a sports league or leagues. It is envisioned that an entity can have more than one function or responsibility in system 100. For example, participant 108 may also be an customer 102.

### EXAMPLE METHODS

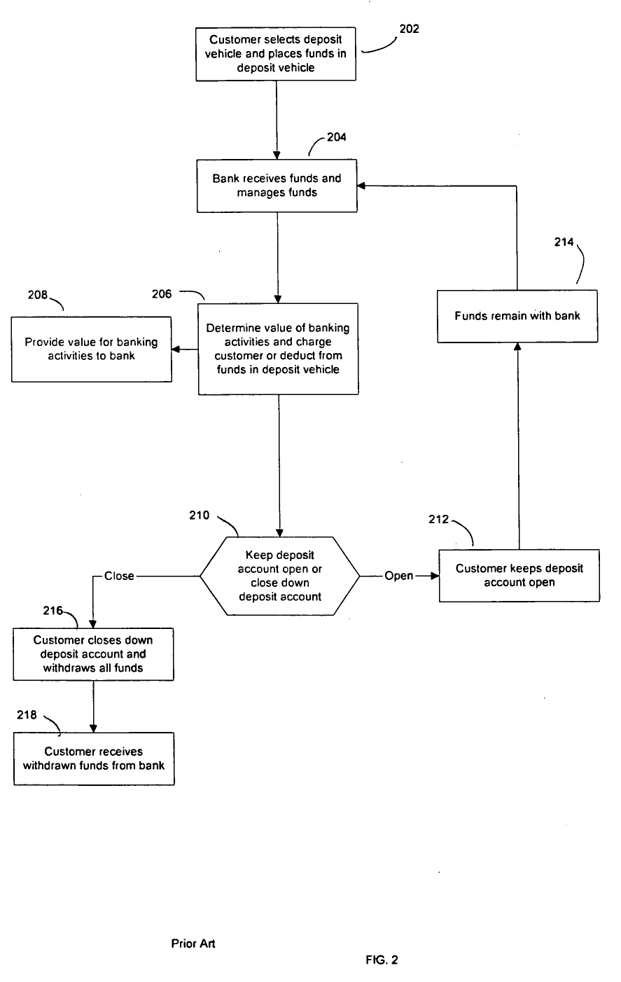

Referring now to FIG. 2, an example banking process, without the invention, is illustrated. At step 202, customer 102 selects a deposit vehicle and places funds in the deposit vehicle. There are a number of different possible deposit vehicles and the particulars of the vehicle are not particularly relevant to the invention.

Examples of deposit vehicles include all types of savings, checking and CD products, including money market accounts, interest checking accounts, high-yield savings accounts, as well as any other types of banking vehicles which allow a customer to deposit and store funds or equity for some period of time. The duration of time may be long or short.

At step 204, bank 104 receives the funds from customer 102 and bank 104 manages the funds. Managing the funds is intended to be a broad term, and may include all the services, activities, and functions required of a bank managing or operating deposit products. In particular, managing the funds may include paying any interest which customer 102 is entitled to receive; clearing and processing checks which customer 102 writes against funds in his account; clearing and processing ATM and debit card transactions which customer 102 makes; clearing and processing deposits which customer 102 makes or receives into his account, as well as payments which customer 102 makes from his account, where any of these deposits and payments may take place in person at a branch office, through ground mail, over the internet, through fax, electronically, through a wire payment, or in any other manner which customer 102 may pay, receive, or deposit funds; clearing and processing any transfers, online banking services, or other cash management services related to customer 102's deposit account; and fulfilling all the reporting and regulatory functions necessary for managing a deposit product, such as sending customer 102, as well as the requisite government authorities, account statements and tax statements.

At step 206, a value or fee for banking activities is determined. Bank 104 typically determines the value or fee for banking activities. The value for banking activities may include a standard fee for managing the funds in the deposit account. The value for banking activities may also include other types of flat-rate and variable-rate fees. Furthermore, the value for banking activities may include account setup fees, account maintenance fees, account administration fees, account operation fees, ATM fees, debit card fees, check writing fees, cash management fees, wire fees, statement and reporting fees, inactivity fees, excess activity fees, postage and handling fees, market information fees, exchange fees, software fees, prime brokerage fees, banking advice fees, and many other types of fees which may be charged by bank 104 for banking activities, as well as for any products and services which may be bundled with the banking process.

The amount of this value for banking activities is charged to customer 102 according to some schedule, and at step 208, bank 104 receives the value for banking activities.

At step 210, customer 102 decides whether to keep his account open, or close down the account and withdraw all the funds.

If customer 102 decides to keep his account open, then at steps 212, 214, the funds remain with bank 104 for management.

If customer 102 decides to close down the account, then at step 216, customer 102 closes down the account and withdraws all the funds, and at step 218, customer 102 receives the withdrawn funds from bank 104.

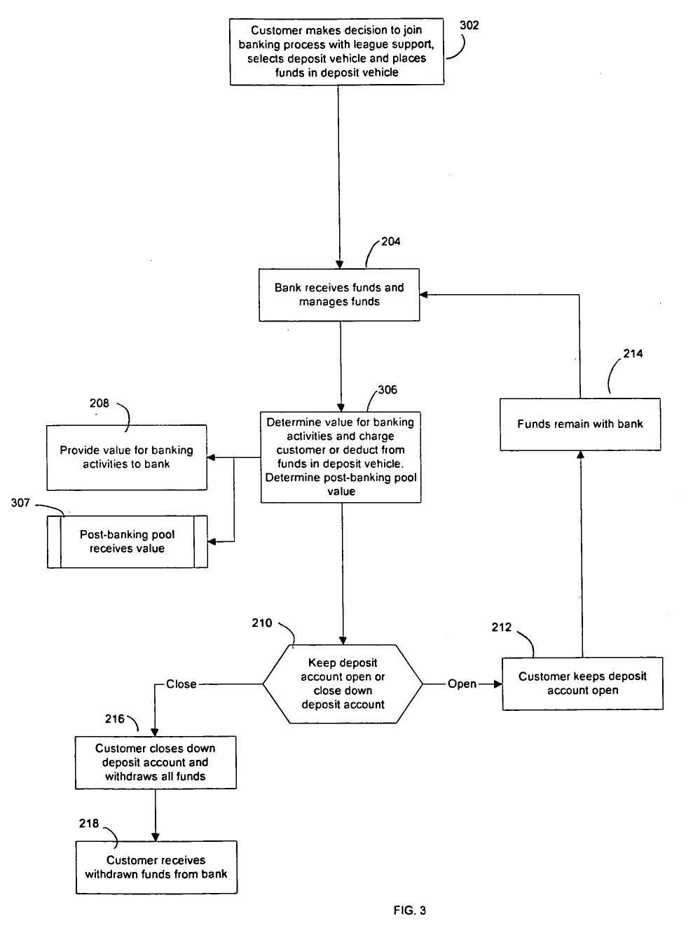

Referring now to FIG. 3, an embodiment of the invention is illustrated. In the figures, steps that are the same or substantially the same are identified with the same numbers.

In FIG. 3, at step 302, customer 102 makes a decision to join the banking process with league support.

At step 204, bank 104 receives the funds from customer 102, and bank 104 manages the funds.

At step 306, the value for banking activities is determined, and a post-banking pool value is also determined. The value for banking activities is the amount that is paid or credited to bank 104 for managing the funds in the deposit product. The post-banking pool value is available for allocation to eligible entities in a sports league. Entities in a sports league generally include a league sanctioning body 106, participants 108, sponsors 110, indirect sources 112, non-league related recipients 114, and owners 116. In certain circumstances the entities in a sports league may also include customer 102 and bank 104.

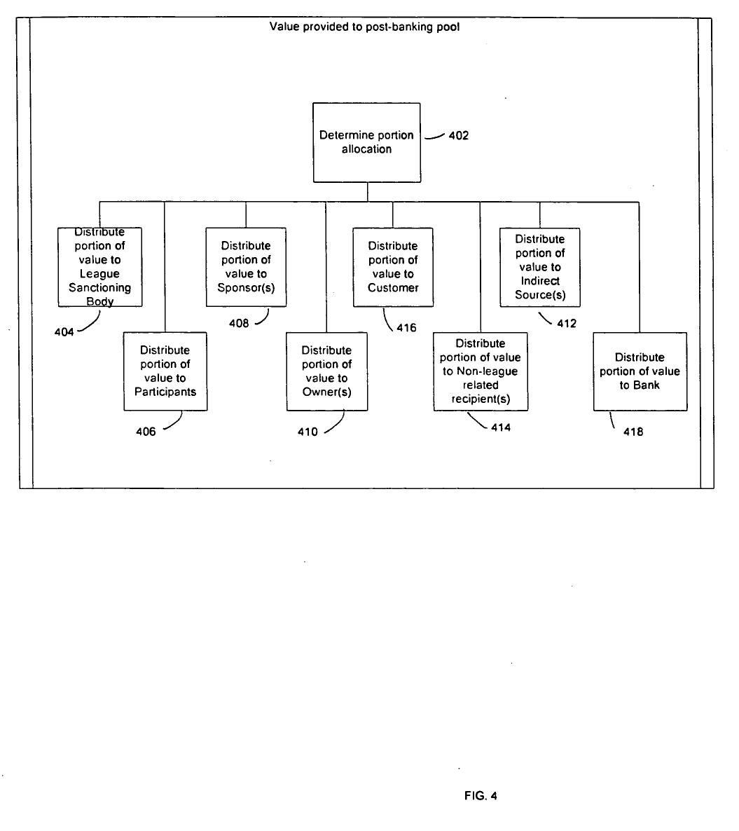

At step 307, the post-banking pool value is allocated among eligible entities in the sports league. The process for allocating the post-banking pool value is illustrated further in FIG. 4.

The process for determining the post-banking pool value may consider any of the factors used to determine the value for banking activities, as well as any other factors system 100 deems relevant. The dollar value of the post-banking pool may be as low as nothing, or as high as the value of banking activities.

The other steps of FIG. 3 are the same or substantially the same as illustrated in FIG. 2, and described above.

Referring now to FIG. 4, at step 402, system 100 determines how to allocate the post-banking pool value among the sports league entities. As previously discussed, entities in a sports league generally include league sanctioning body 106, participants 108, sponsors 110, indirect sources 112, non-league related recipients 114, and owners 116. The allocation may be some form of a division among some or all of these sports league entities, or it may be an allocation to only one of the sports league entities. Once the allocation is determined, then at steps 404-414, the respective sports league entities receive the allocated portions of the post-banking pool value.

The mechanics used by system 100 for the allocation process of the post-banking pool value may be based on any splitting formula and on multiple factors, such as: the entity's history with the league; the entity's contributions or assistance to participant campaigns, the league, or the banking process; the participant's performance and their related league competition standings; the need or desire to market the league or league products; the desire to donate money to a charity or another non-league recipient; or the need or desire to construct new league facilities or improve and update existing league facilities.

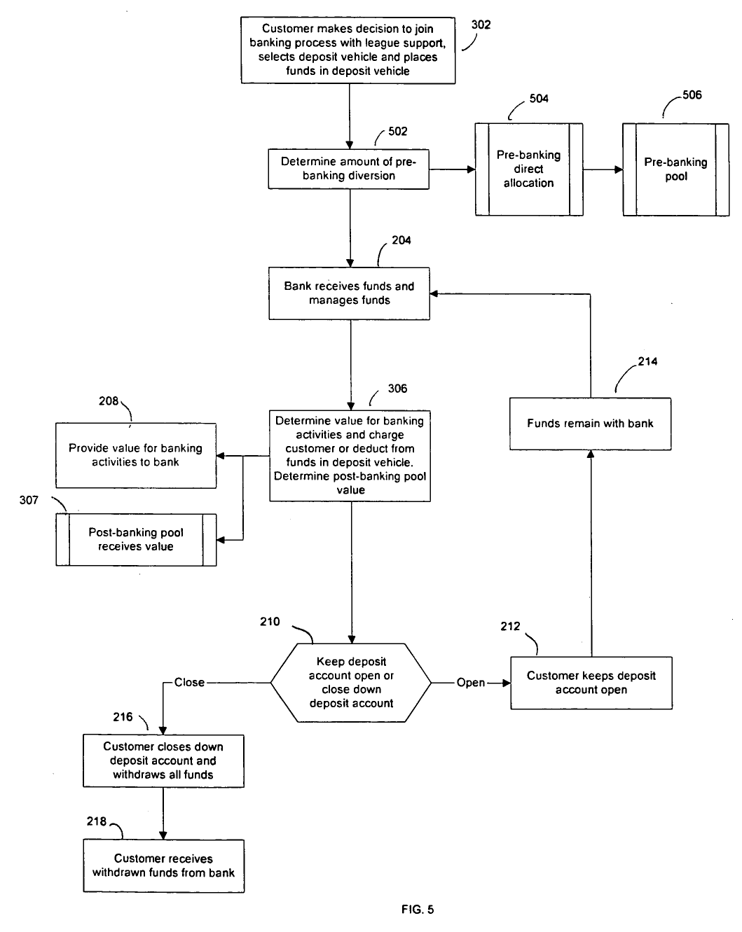

Referring now to FIG. 5, in another embodiment, after customer 102 chooses to join the banking process with league support at step 302, then at step 502, a portion of the funds are diverted before they are placed in the deposit product. Any entity in system 100 may divert funds at step 502. The funds may be diverted for any reason. For example, an entity other than customer 102 may divert the funds in order to secure the pre-payment of any fees which it anticipates will be related to managing the funds in the banking process. In another embodiment, customer 102 may divert the funds based on a non-banking related decision which customer 102 makes. For example, customer 102 may decide to allocate funds to a non-league related recipient, such as a charity, before the funds are placed in a deposit product.

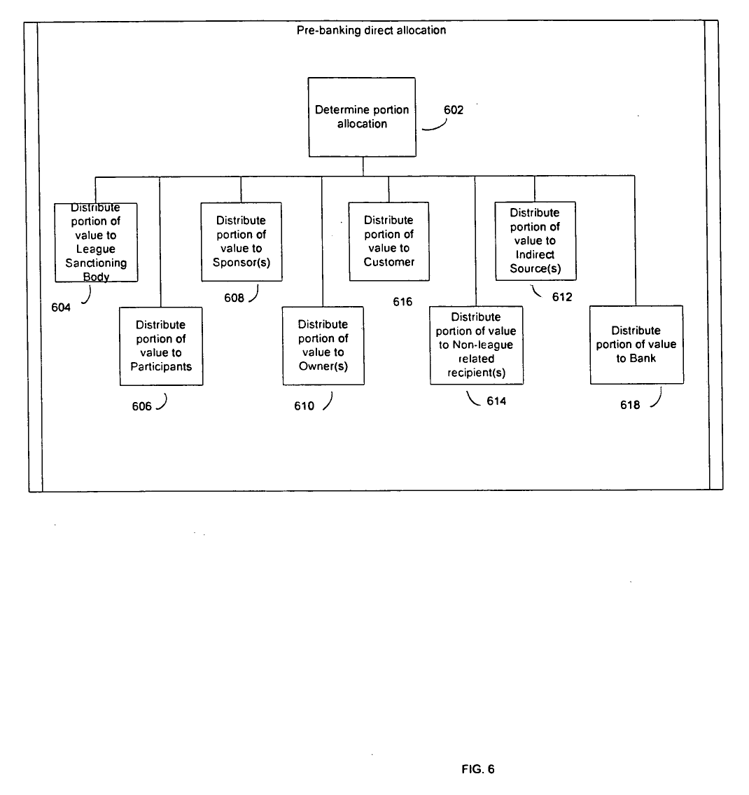

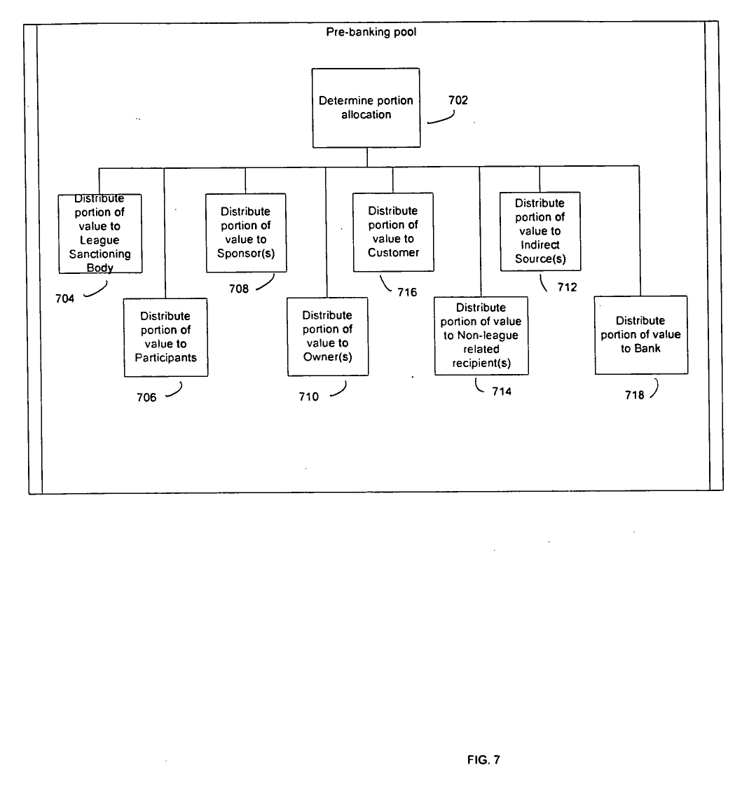

At step 504, any entity in system 100 makes a direct allocation, as further illustrated in FIG. 6 and described below. The allocation at step 504 may be all, some, or none of the amount diverted at step 502. If the full amount diverted at step 502 is not directly allocated at step 504, then at step 506 the remainder is placed in a pre-banking pool, and the pool is allocated as illustrated in FIG. 7. The remaining steps in FIG. 5 are the same or substantially the same as the steps illustrated in FIG. 3.

Referring now to FIG. 6, at step 602, any entity in system 100 determines how to allocate the amount diverted at step 502. This is a pre-banking direct allocation among the sports league entities. The direct allocation may be some form of a division among the entities, or it may be an allocation to only one or some of the entities. The allocation at step 602 may be based on any splitting formula.

Once the allocation is determined, then at steps 604-614, league entities receive any pre-banking direct allocation.

Referring now to FIG. 7, at step 702, one or more entities of system 100, but generally not customer 102, allocates the pre-banking pool among the sports league entities. The allocation may be some form of a division among the sports league entities, or it may be an allocation to only one or some of the sports league entities. The allocation process used by system 100 for the pre-banking pool (e.g., FIG. 7) may or may not be based on factors that are similar to the allocation process for the post-banking pool (e.g., FIG. 4). Once the allocation is determined, then at steps 704-714, league entities receive any allocated portions of the pre-banking pool of funds. The post-banking allocation process illustrated in FIG. 4 may be different than the pre-banking pool allocation process illustrated in FIG. 7.

In the embodiments described herein, customer 102 and bank 104 receive a value at steps 218 and 208 respectively. Therefore, they do not typically receive a pre-banking direct allocation, or an allocation from the pre-banking pool or from the post-banking pool. However, it is possible in some instances that customer 102 and bank 104 receive a pre-banking direct allocation, or an allocation from the pre-banking pool or from the post-banking pool, as illustrated in FIGS. 4, 6, and 7. When customer 102 or bank 104 receives an allocation, at least one other entity of system 100 also receives an allocation, although this other entity besides customer 102 or bank 104 may not necessarily receive the allocation from the same source. Rather, the allocation may be from another of the three total sources from which an allocation can come (e.g., the pre-banking direct allocation, the pre-banking pool, or the post-banking pool). As an example, bank 104 may receive a pre-banking direct allocation, and league sanctioning body 106 may receive an allocation from the post-banking pool.

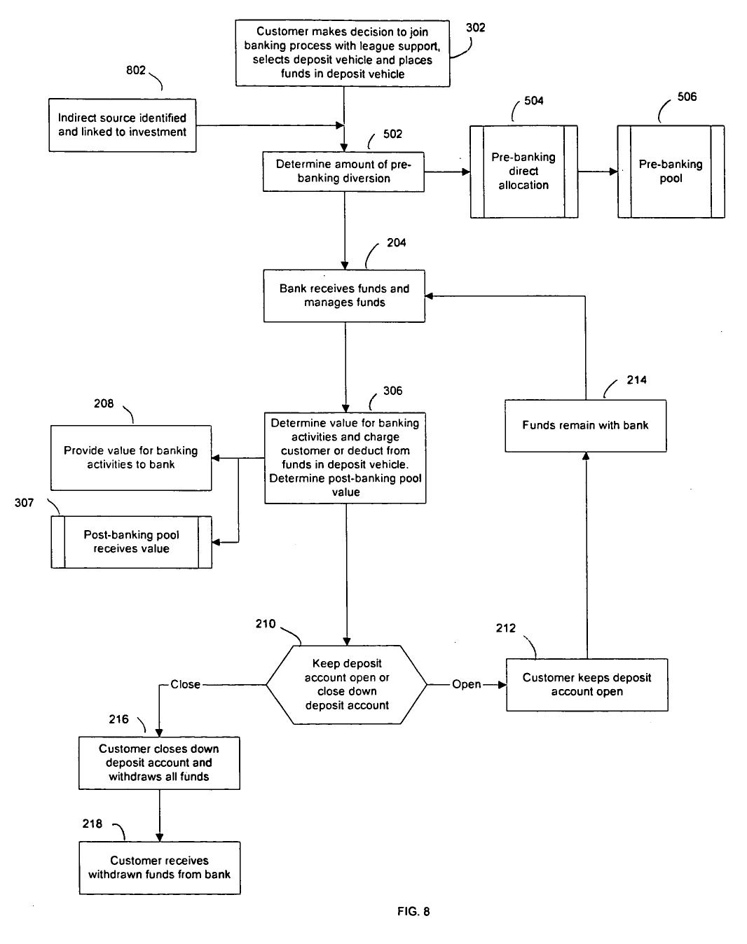

Referring now to FIG. 8, in another embodiment, after customer 102 chooses to join the banking process with league support at step 302, then at step 802, an indirect source is linked to the banking process and the associated indirect flow is added to the banking process. The indirect flow from step 802 is combined with the direct flows from step 302, and at step 502, any diversion occurs before the funds are placed in a deposit vehicle. The remaining steps in FIG. 8 are the same or essentially the same as the steps illustrated in FIG. 5.

As illustrated in FIG. 8, once an indirect source of funds is identified and linked to the banking process, the indirect flow can be allocated by a direct allocation or pool (steps 504, 506) before the funds are placed in a deposit vehicle, or applied to the deposit vehicle where they can be later allocated to the post-banking pool (step 307).

The following describes one embodiment of how an indirect flow may originate from an indirect source, and then be applied to the banking process at step 802. An entity of system 100 may designate various types of incentives for transactions involving participating products and services in a sales medium/commerce network, and the indirect flow may originate from all of, a portion of, or a multiple of the payment price, or the incentive, from one or more of these transactions involving participating products and services. The sales medium/commerce network is discussed further below. The term payment price is intended to be a broad term, and may include any type of payment structure which a customer may use when paying for a product or service. Examples of payment structures include a cash payment; a check payment; a card payment, such as a debit card, check card, credit card, stored value card, gift card or smart card payment; an electronic payment; a one-time payment at the time of purchase; a payment plan involving a security deposit arrangement; a recurring billing plan for an ongoing service; or an arrangement such as a line of credit, an extended payment plan, an interest only loan plan, a mortgage plan, a lease plan, a rental plan, or some other type of payment plan where a customer can pay for a transaction over time. The term incentive is also intended to be a broad term, and may include any type of enticement which may increase the likelihood that a transaction involving a participating product or service takes place between a vendor and customer 102. The term incentive may include any type of financial or non-financial reward which is given to customer 102, either before, along with, or after a transaction takes place involving a participating product or service. Examples of incentives include a cash discount which may be netted out of the payment price; a cash rebate which may be redeemed after a transaction; a coupon which may be used to receive a discount; a credit which may be used for a later transaction; a product or service which is given to customer 102 for free, for a fee, before the transaction, during the transaction, or after the transaction, where this product or service has a cash value which can be unlocked by system 100; or an incentive which is based in non-monetary units, such as points, miles, and other non-monetary terms which have financial value because they may be converted at some later point into indirect fund flows by entities in system 100, even in short duration transactions where system 100 is used as an instantaneous exchange mechanism, filtering mechanism, financial aggregation mechanism or banking mechanism for converting these non-monetary units into indirect fund flows, entering these indirect fund flows into the banking process at step 802, and allowing customer 102 to withdraw the converted funds at steps 216, 218.

The following are some examples of how an indirect flow may originate from all of, a portion of, or a multiple of the payment price, or the incentive, from one or more transactions involving participating products and services. In one example, sponsor 110 offers a 10% discount on a book which normally has a price of $30 before the $3 incentive, or the equivalent of 10% of the $30 price, is factored into the transaction price. In this example, customer 102 may make a $30 payment to sponsor 110 during the transaction, and at some later point in time, sponsor 110 may make a cash deposit of $3, or the equivalent of the full incentive, into customer 102's deposit account as an indirect fund flow. In another embodiment of this example, sponsor 110 may allow customer 102 to split the 10% incentive into two parts: one part which is received as an indirect fund flow, and a second part which is received as some form of an incentive other than an indirect fund flow, such as a cash rebate which customer 102 receives independent of the banking process. For instance, sponsor 110 may allow customer 102 to pay $28 for the $30 book during checkout at the store. Assuming the incentive is still 10% of the undiscounted $30 payment price, this allows customer 102 to receive a cash discount of $2 during payment, and thus create a situation where $2 of customer 102's total incentive of $3 does not enter the banking process as an indirect fund flow. In this scenario, customer 102 receives $1, or the equivalent of the remaining part of the $3 incentive, as an indirect fund flow into the banking process. In another embodiment of the ongoing example, sponsor 110 may make more than one indirect fund flow on behalf of customer 102, even though customer 102, through his decision to pay for the $30 book, completes only one transaction. For example, sponsor 110 may offer customer 102 an extended payment plan for the $30 book, where customer 102 is allowed to pay for the $30 book in two equal monthly payments of $15 each. In this instance, sponsor 110 may make 2 separate indirect fund flows of $1.50 each, where both of these two separate $1.50 indirect fund flows are placed in customer 102's deposit account, and where each of these two separate $1.50 indirect fund flows is meant to reimburse customer 102 for the 10% discount he is entitled to receive on each of his $15 monthly payments. In another embodiment of the ongoing example, sponsor 110 may link the incentive on this $30 book to other products and services. For example, sponsor 110 may only offer the 10% discount if customer 102 is willing to pay for at least 10 books in one payment transaction. In another embodiment of the ongoing example, sponsor 110 may link the incentive on this $30 book to one or more other transactions which customer 102 has made with sponsor 110 during a certain timeframe. For example, sponsor 110 may only offer the 10% discount on this $30 book if customer 102 has already paid for at least 10 other books in the last calendar year. In another embodiment of the ongoing example, sponsor 110 may link its 10% incentive to another incentive offered by one or more other entities in system 100. For example, sponsor 110 may only offer a 10% discount on the $30 book if customer 102 is willing to use a specific type of debit card to pay for the $30 book, where the debit card specified is the one which is linked to customer 102's deposit account with bank 104. In another embodiment of the ongoing example, one or more entities in system 100 may designate incentives that are based in non-monetary units, where these non-monetary units have a cash value which can be unlocked by system 100. For example, sponsor 110 may offer 100 points for every $100 that is spent on books by customer 102. When customer 102 pays $100 for 3 books, customer 102 receives 100 points from sponsor 110. At some point, system 100 allows customer 102 to convert some or all of these 100 points into an indirect fund flow at an exchange rate of $5 for every 50 points which are redeemed.

The following describes another embodiment of how an indirect flow may originate from an indirect source, and then be applied to the banking process at step 802. The indirect flow may consist of funds which an entity in system 100 decides to reward to customer 102 because of some milestone or threshold which customer 102 has reached, or some indirect fund flow opportunity for which customer 102 has qualified, even if this milestone, threshold, or opportunity is not directly linked to a payment transaction for a participating product or service affiliated with the banking process. For example, bank 104, or some sponsor 110 who is a financial entity, may designate an existing incentives program, such as a membership rewards program for one of its own consumer finance products, as being a source of indirect fund flows for the banking process. Customer 102 may accumulate 10,000 points in one of these membership rewards programs, where 5,000 of these 10,000 points were earned by paying for products and services which didn't even have payment incentives attached to them by an entity in system 100, and where the other 5,000 of these 10,000 points were accumulated in ways not even related to payment transactions at all, such as through an arrangement where 5,000 points were given out for free to customer 102 when he joined the membership rewards program. An entity in system 100 may allow customer 102 to redeem some or all of these 10,000 points for an indirect fund flow into the banking process at an exchange rate of $10 per 1,000 points. In another embodiment, bank 104 may offer an opportunity where it, as bank 104, makes an indirect fund flow of $10 into customer 102's account on every 2 year anniversary which customer 102's account remains open with bank 104. Typically, an indirect fund flow is related to at least one specific payment transaction; however, it is possible, such as in the examples just provided, that an indirect fund flow does not originate from an indirect source specifically related to one or more specific payment transactions, but rather originates from an indirect source generally related to one or more products, services, or entities of system 100.

Indirect fund flows may result from transactions which customer 102 makes at physical store locations, as well as through the internet, through mail order, over the phone, or any other means through which vendors may sell to customers. In further embodiments, sponsor 110 may offer incentives for products and services sold in its own storefronts, or for its own products and services which are sold out of other vendors' storefronts, even if these other vendors themselves are not affiliated with system 100. For example, sponsor 110 may offer a $1 indirect fund flow into customer 102's account for every proof of purchase which is redeemed from the inside cover of any book which it publishes, regardless of where customer 102 buys the book. Any entity in system 100, and not just sponsor 110, may offer incentives, serve as an indirect source, grant opportunities for customer 102 to receive indirect fund flows, or provide indirect fund flows into the banking process. For example, league sanctioning body 106 may offer incentives related to ticket prices, league merchandise, or services provided to fans. Any entity in system 100, such as bank 104, may prevent other entities in system 100, such as league sanctioning body 106, as well as some sponsors 110, from serving as indirect sources, granting opportunities for customer 102 to receive indirect fund flows, offering purchase incentives on their products or services, or providing any indirect fund flows into the banking process, even if these entities which are being excluded are part of system 100 because of their default roles as stakeholders or entities in the sports league. Entities in system 100, and more particularly bank 104 and league sanctioning body 106, may charge an entrance fee, an inclusion fee, or another similar type of fee for any entity in system 100 who wants to receive the basic privilege of being affiliated with the indirect fund flow process, such as serving as an indirect source, granting opportunities for customer 102 to receive indirect fund flows, offering incentives on its products and services, or providing indirect fund flows into the banking process.

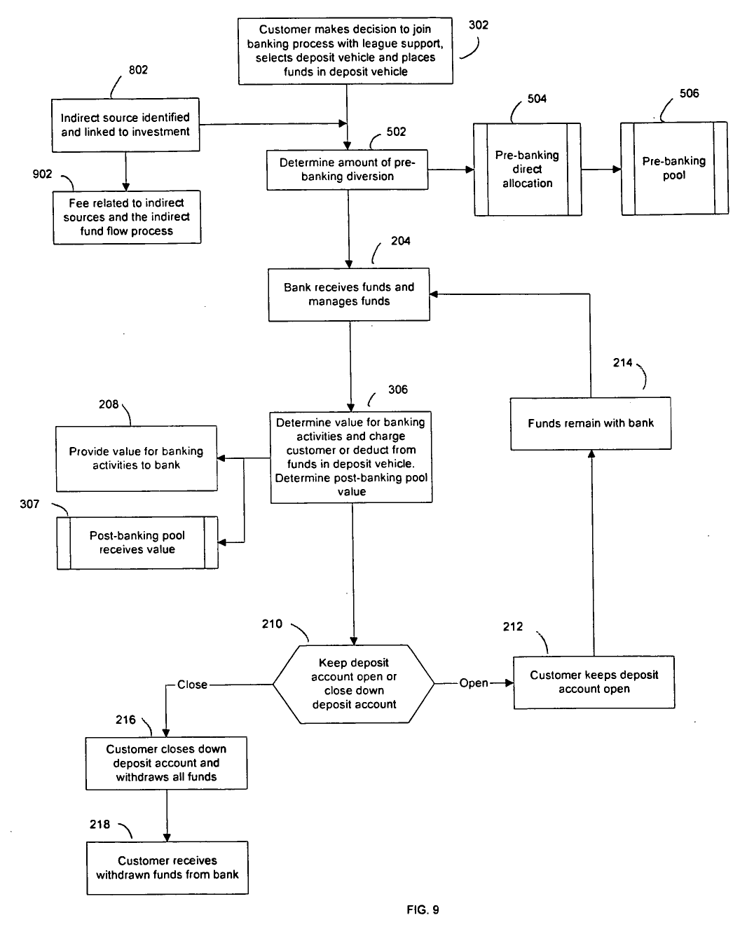

Referring to FIG. 9, at step 902, these entrance or inclusion fees may be paid directly to the one or more entities in system 100 who are charging the fees, and these fees may or may not become part of the pre-banking direct allocation process before the funds are placed in the deposit vehicle, and these fees may or may not become part of the pre-banking pool value or the post-banking pool value. In addition to these entrance and inclusion fees, entities in system 100 may also separately impose many types of transaction fees on the indirect fund flows which enter the banking process at step 802. These transaction fees may be charged to customer 102, or these transaction fees may be paid by another entity in system 100, such as an indirect source, an entity offering an incentive, an entity granting an indirect fund flow opportunity to customer 102, or a provider of indirect fund flows to the banking process.

In each embodiment where an indirect flow originates from an indirect source, customer 102 communicates with an entity in system 100 in order to inform this entity that he is indeed customer 102, and thus entitled to receive the indirect fund flows being offered. This communication between customer 102 and the entity in system 100 may occur any time, including before, during, or after a transaction; and if the indirect flow is related to a milestone or threshold not affiliated with a transaction, the communication may also occur anytime. All or a portion of the indirect flow itself may take place at the same time as the communication between customer 102 and the entity with whom customer 102 communicates, or all or a portion of the indirect flow may take place immediately after the communication. All or a portion of the indirect flow may be delayed until a later date. All or a portion of the indirect flow may be batched with other indirect flows on a specific later date or recurring interval of time. One or more entities in system 100 may batch indirect flows together, or one entity in system 100 may make an indirect fund flow on behalf of another entity in system 100.

In one embodiment, customer 102 communicates with the vendor or with another entity in system 100 using some form of a proof of purchase from the participating products and services for which he has paid. Any proof of purchase is suitable, such as a store receipt or a proof of purchase which is part of the product labeling. In another embodiment, customer 102 communicates with the vendor or with another entity in system 100 using a customer identification tool which may be used in conjunction with, or in place of, a proof of purchase. This customer identification tool may be an account number which system 100 assigns to customer 102, much like the account numbers which financial firms typically assign to clients who deposit funds with them in banking accounts. System 100 may use the account number as a way for any entity in system 100 to distinguish one specific customer 102 from another customer 102. In one embodiment, the account number may be a new and unique account number which is created and assigned to customer 102 specifically for use in the banking process or the indirect fund flow process. In another embodiment, the account number may be the same number which customer 102 already has been assigned by another entity in system 100, such as, but not limited to bank 104 or league sanctioning body 106 for activities bundled with, or even independent of the banking process or indirect fund flow process.

Customer 102 may be given a sheet of paper, an ID, or some other form of identification material which can verify this account number for customer 102 or can verify customer 102 is part of the banking process, even if no account number is incorporated into the identification material. This additional form of identification may be a debit card, an ATM card, a bundled debit/ATM card, or some similar type of card which would normally be issued for any customer who opens up a deposit account with bank 104. The account number may be printed on the card, or it may be embedded into the card's magnetic strip or some other part of the card. The card issued to customer 102 may be a new card which is specifically created for this banking process application. In this instance, this new card may be set up so that later on, under the scenario that customer 102, system 100, bank 104, or the issuing card firm (in the event bank 104 is not the issuing card firm) should decide it is desirable, the card may become activated for other types of card privileges with an entity in system 100, or with an entity outside of system 100. The term card privileges is intended to be a broad term, and may include privileges such as debit card, credit card, check card, ATM card, prepaid card, smart card, gift card, or any other types of banking, cash management, or consumer finance privileges which may be easily linked to or bundled with the card; as well as many other types of privileges including uses in retail applications, such as credit, gift, or debit privileges for a specific store or retail chain; in membership clubs; in affinity programs, such as prepaid discounts which are stored on a card; in applications involving operating equipment or devices, such as cards programmed to start or operate vehicles or machines; in stored-value or prepaid cards used in the utilities, transportation, telecom, parking, or related applications where stored value and prepaid cards can be used; or in applications involving official government, corporate, or personal identification functions. In another embodiment, system 100 may not issue customer 102 a new card, but rather may allow customer 102 to use an existing card which customer 102 already has based on some relationship which customer 102 has with an entity that may or may not be in system 100, including those relationships which are affiliated with one or more of the previously listed card privileges which may be linked to or bundled with a card. In this embodiment where an existing card is used, system 100 may bundle customer 102's account number for the banking process into the existing card product, and thus allow customer 102 to simultaneously use his card as a customer identification tool for accruing indirect fund flows as well as a standard tool for receiving his existing card privileges. For example, customer 102 may use his card as a debit card to pay for item with a payment incentive attached to it, and also at the same time, use his card to communicate to the vendor that he is entitled to receive his transaction incentive.

In one embodiment, the card may be swiped through, or read by a card reading device at a physical store location. In other embodiments, the card information may be transmitted to an entity in system 100 over the internet; over the phone; through written documents that are sent by email, ground mail, or fax; or the card information may be communicated through any other means which cardholder information may be exchanged between customer 102 and an entity in system 100.

The term direct fund flows indicates that the funds enter the banking process directly from customer 102, such as at step 302. These direct fund flows are differentiated from indirect fund flows, such as illustrated at step 802 in FIG. 8, because the indirect fund flows always pass through, or become affiliated with an indirect source before reaching the banking process; direct flows, in contrast, typically enter the banking process directly from customer 102 based on an banking decision which customer 102 makes, and don't enter through an indirect source.

Customer 102 may attain one or more thresholds of activity in the indirect fund flow process or the banking process. These thresholds of activity may be set by any entity in system 100 (besides customer 102), and they may include measures of performance which customer 102 may attain with respect to one or more entities (besides customer 102) in system 100, or which customer 102 may attain with respect to system 100 as a whole.

The following is a description of how with respect to the indirect fund flow process, an entity in system 100 may set a threshold of activity which customer 102 may attain. In one example, sponsor A may deem that customer 102 has attained a threshold of activity if customer 102 accumulates $50 or more of indirect fund flows in one calendar year from transactions involving sponsor A's products and services. In this example, sponsor A would be setting a threshold of activity at $50. The following explains how customer 102 could attain this threshold of activity. If sponsor A sells books, and sponsor A offers a 10% indirect fund flow into the banking process for all participating books which customer 102 purchases from sponsor A, customer 102 could achieve this $50 threshold of activity versus sponsor A if customer 102 purchased at least $500 worth of participating books in one calendar year, since under this scenario, customer 102 would earn $50 of indirect inflows into the banking process from sponsor A (where $50 is 10% of the $500 worth of books purchased). In another embodiment, bank 104 may deem that customer 102 has attained a threshold of activity if customer 102 accumulates indirect fund flows of $10 or more from at least 10 different sponsors in one calendar year period. It is possible for thresholds of activity to be set based on any types of performance or activity levels which an entity in system 100 can set, and thus use to judge customer 102's performance in the indirect fund flow process. Thresholds of activity may be based on the dollar amount of indirect fund flows accumulated, the absolute number of transactions completed, the time frame of the transactions completed, and any other factors related to the payment price, the goods and services themselves, or the incentives affiliated with the indirect fund flow process, as well as any milestones, thresholds, or opportunities which are affiliated with the indirect fund flow process.

The following is a description of how with respect to the banking process, an entity in system 100 may also set a threshold of activity which customer 102 may attain. Bank 104 may deem that customer 102 has attained a threshold of activity if customer 102 has accumulated an account balance of $500 or more in his banking account, or if customer 102 has completed more than 10 debit card transactions within one quarterly calendar period. System 100 as a whole may set similar types of thresholds of activity for customer 102 to attain. It is possible for thresholds of activity to be based on any factor which is used to judge customer 102's activity, performance, or standing in the banking process.

Once customer 102 has attained a threshold of activity versus any entity in system 100, or versus system 100 as a whole, customer 102 is entitled to receive, either for free or by paying, numerous exclusive products and services, where these exclusive products and services are available from entities in system 100, or from system 100 as a whole, and where these exclusive products and services have one or more corporate identifiers of entities in system 100 incorporated into them. The term incorporated is intended to be a broad term, and may include corporate identifiers that are fixed on, printed on, embedded in, stuck on, or somehow other attached, included, or part of the exclusive products and services. The term exclusive products and services is also intended to be a broad term, and may include all sorts of products and services which are used in the banking process, the indirect fund flow process, generally related to the sports league in general, or not even related to the sports league or the banking process at all. The products and services generally will include customer identification tools, such as debit cards, credit cards, and other forms of ID; but they may also include sports equipment related to the league, such as tennis rackets, golf clubs, racing helmets; as well as apparel, such as hats, t-shirts, and jackets which reference system 100, one or more entities in system 100, the banking process, or the indirect fund flow process. In each case, the exclusive products and services will have incorporated into them at least one or more corporate identifiers of any of the entities in system 100, or system 100 as a whole, whose thresholds of activity have been attained. The term corporate identifiers is also intended to be a broad term, and may include an entity's name, logo, slogan, emblem, sound clip, picture, likeness, scent, or any other trait, feature, or characteristic of the entity which could be recognizable by customer 102 or any other person or entity affiliated, or not even affiliated with the league.

For example, if customer 102 has achieved a threshold of activity versus sponsor A (because customer 102 has accumulated $50 worth of indirect inflows from sponsor A in one calendar year period), customer 102 would be entitled to receive a new identification card, such as a debit card, which has a logo of sponsor A, the company from which customer 102 has attained the threshold of activity, printed on the face of the debit card. In another example, if customer 102 has attained a separate threshold of activity versus sponsor B in addition to the threshold of activity customer 102 has received from sponsor A, customer 102 may receive a debit card with the logos of sponsor A and sponsor B printed on the face of the same debit card. Customer 102 may receive these new debit cards either for free, or customer 102 may pay one or more sponsors, some other entity in system 100, or system 100 as a whole, for these exclusive cards. In another example, system 100 may allow customer 102 to purchase a t-shirt which is exclusive because printed on the t-shirt are all the corporate logos of the sponsors which customer 102 has accumulated at least $50 worth of indirect fund flows over the course of the last calendar year. If one customer 102 has earned $50 from at least six different sponsors, this customer 102 could purchase a t-shirt with these six different sponsors' logos on the t-shirt, while if another customer 102 only accumulated $50 from four different sponsors, this other customer 102 would only be able to purchase a t-shirt with four sponsors' logos on it. In these embodiments, the thresholds of activity are used by entities in system 100 to regulate the exclusivity of corporate identifiers on the products and services which customer 102 is able to receive, such as debit cards, other ID cards, clothing apparel, or sports equipment.

System 100, and more particularly bank 104, may also use thresholds of activity, including those based on both the indirect fund flow process as well as the banking process, to govern and regulate banking services which customer 102 is able to receive. For example, bank 104 may stipulate that no customer 102 can receive overdraft protection for his deposit account unless he earns an average of at least $50 a year in indirect fund flows into the banking process. Bank 104 may impose these restrictions in order to help improve its risk-control policies, especially regarding the suitability of certain banking services for certain banking customers. In another example, bank 104 may take the dollar amount of every customer 102's calendar year indirect fund flows, and divide it by the average daily account balance in customer 102's deposit account over a one year period of time. For example, if customer 102 earned $50 worth of indirect fund flows in one calendar year, and this same customer 102's average daily account balance over a one year period was $500, this same customer's annual indirect fund flows would amount to 10% of his average daily account balance over a one year period. Bank 104 may use this 10% ratio to help regulate the risk of the banking services customer 102 uses. This 10% figure would give bank 104 some insight into customer 102's cash flow profile, since it would indicate that customer 102 could potentially cover a 10% overdraft loan, even if customer 102 did not have sufficient credit to pay back the overdraft loan.

Customer 102 may achieve more than one threshold of activity at the same time. For example, customer 102 may achieve two thresholds of activity, one from sponsor A because he has accrued $50 of indirect inflows from sponsor A in the last calendar year, and one from sponsor B because he has accrued indirect inflows in more than 10 transactions in the last calendar quarter from sponsor B. Customer 102 may achieve more than one threshold of activity from the same entity in system 100 at the same time. For example, customer 102 may achieve one threshold of activity from sponsor A when he accumulates $50 of indirect inflows in one calendar year from sponsor A, and then the same customer 102 may achieve a higher threshold of activity also from sponsor A when customer 102 accumulates more than $100 worth of indirect inflows in one calendar quarter also from sponsor A. Customer 102 may also achieve the same threshold of activity from two or more entities in system 100 at the same time. For example, sponsor A and sponsor B might both set thresholds of activity at $50 of indirect inflows in one calendar year, and customer 102 may accumulate $50 of indirect inflows from both sponsor A and sponsor B in the same calendar year.

In a process similar to the way thresholds of activity are set and attained, system 100, as well as any other entity in system 100 (excluding customer 102), may also set, as well as attain, thresholds of performance in the indirect fund flow process or the banking process. These thresholds of performance, which generally are set by system 100, bank 104, sponsor 110, or league sanctioning body 106, may include all sorts of measures of contribution which any entity in system 100 (excluding customer 102) may attain with respect to system 100, or with respect to any entities in system 100 (excluding customer 102) which have set these thresholds of performance.

For example, one specific sponsor 110 may attain a threshold of performance set by bank 104 if this specific sponsor 110 contributes more than $1 million worth of indirect fund flows into the banking process on behalf of all customers 102 over the course of one calendar year. In another example, one specific sponsor 110 may attain a threshold of performance set by league sanctioning body 106 if sponsor 110 spends more than $2 million a year to advertise and promote the banking process or the indirect fund flow process. In another example, sponsor A, an online retailer, may attain a threshold of performance set by sponsor B, a shipping company. This could occur if sponsor A and sponsor B have a linked incentive, such as would be the case if sponsor B gives a $5 discount to customer 102, but only whenever customer 102 uses sponsor B to ship goods bought from sponsor A's website. Sponsor A may attain a threshold of performance from sponsor B. This could occur if sponsor A steers $1 million of shipping business to sponsor B from website sales. In a further example, one specific sponsor 110 may attain a threshold of performance set by bank 104 if this specific sponsor 110 signs up more than 100,000 new customers 102 for the banking process in one calendar year. It is possible for thresholds of performance to be related to any factors which can be used to judge the contribution by any entity in system 100 (besides customer 102) to the banking process or the indirect fund flow process.

Similar to thresholds of activity, entities in system 100 (excluding customer 102) may achieve a separate threshold of performance from different entities (or system 100) at the same time, more than one threshold of performance from the same entity (or system 100) at the same time, as well as the same threshold of performance from two or more entities in system 100 (or system 100) at the same time.

Once an entity in system 100 has attained a threshold of performance, this entity achieving the threshold of performance is entitled to use one or more corporate identifiers of the specific entities in system 100 from which it has attained a threshold of performance, where these corporate identifiers may be used in any media-related advertising, promotion, or marketing activities which the entity attaining the threshold of performance uses to create visibility for the banking process, the indirect fund flow process, or the relationship or affiliation which itself, or any other entity in system 100 has with the banking process or the indirect fund flow process. It is also possible for thresholds of performance to be used to govern the usage of corporate identifiers on the apparel worn by a participant 108, such as on a hat, jersey, or uniform; as well as on the equipment used by participant 108, such as the panels of a race car, the bag of a golfer, the racket of a tennis player, or the helmet of a motorcycle racer or skateboarder. For example, if one specific sponsor 110 has achieved a threshold of performance from league sanctioning body 106 because sponsor 110 has brought in more than $1 million of indirect fund flows into the banking process in one calendar year, sponsor 110 would be entitled to display a corporate identifier of league sanctioning body 106, such as a special circular orange sticker, on the panels of a racing car it is sponsoring in an auto racing league. In another example, bank 104 may advertise the banking process, and in the advertisement, use corporate identifiers of only those sponsors 110 who have attained certain thresholds of performance which bank 104 has set. To continue this example, in the advertisement just described, bank 104 may only include the names of the sponsors which have brought in $2 million or more a year in indirect fund flows into the banking process, assuming $2 million a year of indirect fund flows was a threshold of performance bank 104 had set for sponsors 110 to attain.

In any embodiment where a corporate identifier is used, including all the embodiments involving thresholds of activity and thresholds of performance, it is possible that more than one corporate identifier is used (for example, if customer 102 has attained thresholds of activity versus two different sponsors, customer 102 may be entitled to receive a debit card with the logos of both of these two different sponsors printed on the same card); it is possible that more than one corporate identifier of the same entity is used (for example, if customer 102 attains two separate thresholds of activity versus the same sponsor, customer 102 may be entitled to purchase a t-shirt which has more than one logo of the same sponsor printed on the t-shirt); and it is possible that joint corporate identifiers created between two or more entities are used (for example, if customer 102 reaches a threshold of activity which has been jointly set by two separate sponsors, customer 102 may be entitled to receive a t-shirt which has one logo on it, where this logo is a corporate identifier shared or jointly owned by two or more separate sponsors).

In one embodiment, system 100, or entities in system 100 may set very high levels for the thresholds of activity and the thresholds of performance, and other times, they may set very low levels, so low in fact that these levels might be met simply by being an entity in system 100, or by being affiliated with the banking process or the indirect fund flow process in any way. Entities in system 100 may require that maintenance thresholds are met by entities who have earned thresholds of activity and thresholds of performance, where if these maintenance thresholds are not met, their threshold status will be terminated. For example, if customer 102 has already attained a threshold of activity by earning $50 of indirect inflows from sponsor A in one calendar year period, customer 102 may have to continue to earn at least $25 in every calendar year period after he's earned the original threshold of activity, or else he will lose his original threshold of activity status. In another example, sponsor A may attain a threshold of performance by contributing $1 million in one calendar year period to advertising the indirect fund flow process, but in order to retain this threshold of performance status, sponsor A may have to contribute at least $500,000 in the next two calendar years to advertise the indirect fund flow process. Entities in system 100 may also impose time limits on how long thresholds of activity and thresholds of performance may last before they expire. For example, customer 102 may attain a threshold of activity by accumulating an account balance of $500 in his deposit account, but if he doesn't keep his account balance over $500 for more than one year, he will lose his threshold of activity status.

In the event customer 102 loses one or more thresholds of activity, either because he does not hit a maintenance threshold or because a time limit expires, customer 102 may be restricted from using any cards he's currently using (if the right to use these cards is based on one or more of the thresholds of activity he's just lost), and customer 102 may be required to now use a card which fits his current threshold of activity status (whatever that may now be as a result of one or more of his lost thresholds of activity).

Entities in system 100 may allow other entities to buy or acquire a threshold of activity status, or a threshold of performance status, in place of hitting the actual thresholds themselves through their own performance, activity, or contribution. For example, bank 104 may allow customer 102 to pay $5 for an exclusive debit card which has the logos of five different sponsors printed on it, even though customer 102 did not attain the requisite thresholds of activity from these five separate sponsors which would normally be required to receive these five logos on the debit card. In another embodiment, an entity in system 100 may make it free for customer 102 to receive exclusive products and services based on thresholds of activity customer 102 attains. In another embodiment, customer 102 may have to pay an entity in system 100, or system 100 as a whole, for the right to receive exclusive products and services (for example, customer 102 may have to pay bank 104 an extra $1 per year per logo which customer 102 has printed on his exclusive debit card, even if customer 102 has attained the requisite thresholds of activity to receive these logos for free, and is not buying the right to receive these logos in place of hitting the requisite thresholds of activity normally need to receive them). In another embodiment, entities in system 100, or system 100 as a whole, may make it free for the other entities in system 100 whose corporate identifiers are used in activities related to thresholds of activity or thresholds of performance. For example, bank 104, the entity issuing the debit cards, may make it a free service for the sponsors whose logos it puts on customers' debit cards, thus giving these sponsors free advertising opportunities. In another example, league sanctioning body 106 may make it free for sponsor 110 to place a corporate identifier of league sanctioning body 106 on the panels of sponsor 110's racecar. In another embodiment, an entity in system 100 may pay another entity in system 100, or system 100 as a whole, in order to use corporate identifier(s) in activities related to thresholds of activity or thresholds of performance. For example, sponsor 110 may have to pay bank 104 a fee of $1 a year for each card that bank 104 issues with sponsor 110's logo printed on it. In another example, bank 104 may have to pay sponsor 110 a fee of $1 a year for each card which has sponsor 110's logo printed on it. When these fees are paid for the right to use corporate identifiers in activities related to thresholds of activity and thresholds of performance, these fees may be in addition to all the other fees these entities are already paying, including entrance or inclusion fees at step 902, fees paid to attain a threshold of activity or a threshold of performance status in place of actual performance or contribution, fees paid to receive or acquire exclusive products and services, as well as any transaction fees on the indirect fund flows entering the banking process. All of the fees just mentioned may be allocated in step 902, or they may be allocated in the pre-banking direct allocation process, the pre-banking pool, or the post-banking pool.

Having described various embodiments of the system and method of the invention, it is helpful to understand some of the advantages of the invention.

Sports sponsors face many risks when they associate themselves with an individual participant in a sports league. One risk is the cost of the financial outlays necessary to keep a participant competitive in a league. These outlays are often quite substantial, and even though they are usually agreed upon in advance, and thus in the short term mostly contained to some preset level or range, over the long term, these outlays can sometimes escalate well beyond their preset or anticipated levels when the pace of technology in the league is increasing at a very rapid rate.

Another risk for sponsors is the potential for damage to the sponsor's existing business (either its sales revenues or its brand name equity) when it associates its corporate image with a participant's image. One key threat this risk poses to the sponsor is that the participant might tarnish his or her own image through some unpopular, criminal, immoral, or disreputable act, or potentially a mental or physical injury to himself or herself that would in turn damage the sponsor's brand name and/or revenue stream.

Sponsors face two additional risks when they sponsor a participant. Sponsors face the risk that the participants they are funding do not perform well in the league standings, and thus do not provide sufficient media exposure for their logos and brand names with the fans. Sponsors also face the risk that they do not receive much, or even any exclusivity protection for the large investments they are making with the participants they sponsor, especially versus the sponsors who make lower dollar value investments in the same league as they do.

Sometimes and hopefully for sponsors, the potential returns coming from the association with a participant outweigh these risks. These success stories usually happen when a sponsor is affiliated with a strong-performing participant who is well-received by the league fans and the greater public. In such cases, the sponsor can see increased marketing visibility, increased sales revenues, or even increased brand name equity through its affiliation with a participant.

Other times, the potential returns coming from a sponsor's association with a participant are overwhelmed by the risks involved. These stories of failure are often a result of sponsors who are affiliated with non-performing participants. In these cases, the sponsors usually stop their affiliation with a participant.

Unsuccessful sponsorship arrangements aren't however limited to non-performing candidates. Even strong-performing participants can lose their sponsors. A sponsor may decide that it doesn't want to continue tying its brand name and/or continue risking its revenue stream in an undiversified manner to only one participant, regardless of how substantial the potential returns are from the sponsorship association. Sometimes, a sponsor feels that ending its association with a participant is the only way to remove the open-ended risk to its firm's value and revenue stream in the event its participant does something unbecoming of what its firm stands for.

A sponsor may also find itself unable to increase its financial outlays in order to keep its participant competitive in a league where the cost of technology and campaigning a strong effort is increasing faster than the marketing returns from sponsoring the participant. Some league sanctioning bodies simply are not able to increase their fan base and the media exposure commensurate with the sponsors' increases in cost levels.

Because of these sponsorship risks for both performing and non-performing participants, some leagues die out altogether over time when enough sponsors cannot justify their financial outlays and their undiversified brand name associations with individual league participants.

Other leagues may not die out, but lose customer attraction, and thus have a smaller and less loyal fan base, when the level of performance stagnates. The league sanctioning body may have to impose caps on technological advancements, or the amount of money that can be spent on certain aspects of a participant's campaign, in order to keep costs sufficiently low for the sponsorship arrangements to make financial sense for the sponsors. Other times, as a league's fan base dwindles, even without league-mandated technological or financial caps, there is a point where only a few sponsors have the financial ability to generate a return on their investments. In these cases, there are only a few participants in the league with the ability to perform strongly, and consequently these few participants often dominate the league results. Whether the leagues die out altogether, or simply stagnate, these sponsorship risks become a social problem when the public loses sports leagues which it could have continued to enjoy if the league sanctioning bodies had been better able to capitalize on their position as the coordinators of events which often draw tremendous fan bases and numerous high-profile sponsors.

Having now described many of the risks sports leagues face, it is worth noting some of the ways which league sanctioning bodies can take actions to potentially help their sponsors receive better risk-adjusted financial returns, as well as help the fans achieve a strong financial value proposition for being associated with the league. In order to understand these methods which league sanctioning bodies can use to achieve these goals, it is helpful to describe the interaction between a sports league's major stakeholders.

Sponsors spend marketing dollars on individual participant campaigns, with the hopes that these investments turn into revenue increases and brand equity returns for their own businesses. Fans watch events, and spend money on league and sponsor merchandise, with the hopes that they will continue to be able to witness high levels of competition from the media outlets the league provides, as well as the venues from which the league chooses to host its sporting events. The league sanctioning body acts as the lead coordinator between these sponsors and these fans. The league sanctioning body mandates event rules and chooses league venues that not only keep costs reasonably in check for sponsors, but also allow for high competition levels for fans.

Some leagues rely less on sponsorship spending, and more on owner spending, media contracts, and merchandise sales as their main source of funding, but these leagues also face similar risks of stagnation and extinction as the sports leagues already described. One critical element which defines a league's success is the ability of the league sanctioning body to provide an economical way for the funding parties, whether they are sponsors, owners, or media partners, to maximize the benefits from their investments, as well as minimize their risks. Throughout this maximization exercise, the league sanctioning body has to make sure not to compromise league competition levels, because if it does, it risks losing its fans, and thus the success of its league no matter how many sponsors or owners it can line up to fund league participants.

For a league to ensure its survivability and success, two events need to happen in order to make sure this delicate, triangular balance does not break down between the sponsors, the fans, and the league sanctioning body. First, the league sanctioning body needs to fully unlock the total dollar value of its large fan base, and it needs to do this in a manner that is beneficial to fans. Second, the league sponsors need to fully unlock the total dollar value of their marketing arrangements that are costing them significant amounts of money each year.

To accomplish these goals, the league sanctioning body needs to coordinate with three other stakeholders—the sponsors, the fans, and the financial community—in order to create financial products and processes that capitalize on the league's critical mass. A league's critical mass comes from one or both of the following two sources. First, the league might have a sizable fan base that has a large marketing and financial dollar value attached to it. Second, the league might have numerous sponsors, which when combined together, create a large network of vendors for a powerful and efficient sales medium between sponsors, fans, and other league entities.

This sales medium/commerce network allows both the fans and the sponsors to benefit from the league's economies of scale. The fans achieve pricing and purchasing benefits when they purchase products and services from this network. The sponsors achieve higher sales volumes, as well as a potentially more brand-loyal customer base, due to the benefits for consumers when consumers purchase items from companies within the league commerce network, as opposed to ones outside the league commerce network. Also, for those sponsors that purchase their own supplies from other companies that also happen to be part of the league commerce network, additional benefits occur.

League banking products can be used to facilitate the introduction of these commerce networks, as well as the ability to capitalize on these league commerce networks. These same league banking products can also be used to lower the risks for all parties in a sports league, and help ensure that the league sanctioning body generates the full revenues it can to ensure the league's existence and success.

In order to create these banking products which allow leagues to function at strong and socially beneficial levels, various steps can happen. Leagues can help raise funds for deposit products directly from customers, regardless of whether these customers are league fans or not league fans. Leagues can also help raise money indirectly by organizing their league entities, such as their sponsors and fans, into a network of marketing linkages (the commerce network) that is set up to partially provide fund flows into the banking process.

Next, with the funds they source, leagues can place, or have placed, these funds with one or a group of financial entities. One of these financial entities will most likely include an retail or commercial bank. From the banking activities, as well as the other financial services which can be bundled with the banking process, sufficient fees can be generated such that the league entities can receive a pool of funds, and the participating financial entities can receive fees for their role in the banking activities. These fees for banking activities, although sufficient to provide for significant funds to the league and the financial entities, can be sufficiently low so that customers, who most likely would be league fans, can still receive after-fees banking benefits.

Sponsors see numerous monetary risk-reduction benefits from these financial products. First, they potentially earn a portion of the fees generated from these league-based banking products. For many sponsors, these fees may be the only direct monetary returns they see on their original cash investments in the sponsorship arrangements, and for those sponsors that aren't already in the media spotlight of the league's top ranks, these fees may serve as an especially meaningful partial recouping of their initial cash investments. Second, sponsors see a reduction in their undiversified single participant risk. Sponsors have newfound potential for participating in the success of the overall league and its financial products. This includes the ability of the sponsors to benefit from the increased sales and marketing opportunities coming from the indirect linkages to the league commerce network. Third, sponsors benefit from the ability to place their logos on the cards used by customers, as well as in the media advertisements which the league and the league entities use to promote the banking product. The sponsors are thus able to broadcast their corporate brand name and image out to the fan base using newfound visual space. Fourth, the sponsors are able to give the fans another reason to be more loyal to their brand in their purchasing habits. This increased brand loyalty stems from the added incentive (receiving an exclusive logo on their card) which is now given to fans if they achieve certain thresholds of buying.

League sanctioning bodies also have their share of monetary and marketing benefits. They can receive revenues in return for marketing, endorsing, or operating the league-related banking products, as well as any league-related product and/or service tie-ins they create to raise indirect capital inflows into the league-related banking process. These newfound financial benefits give league sanctioning bodies the ability to improve and update league venues, and thus potentially provide better and/or safer competition levels for both participants and fans. Aside from the financial benefits, the leagues also see heightened marketing visibility and increased brand name recognition in the deep financial market community. This increased visibility translates into a potentially larger fan base for the league, as well as the ability for the league to command more money from its league sponsors. The league is also in a better position to attract high-profile sponsors willing to spend money on individual participant campaigns now that some of these sponsors' cash outlays may be protected against complete loss, and also now that there are opportunities for sponsors to join the league commerce network. Furthermore, the league sanctioning body benefits from the ability to use the existing technological infrastructure which the banks already have in place. This infrastructure allows the indirect fund flow process to benefit from the proven encryption and security safeguards which the banks have spent years developing and refining.

The bank(s) involved in the process also experience benefits. The bank can attract substantial new assets under management, and thus experience all the related financial benefits that accompany those new assets under management (primarily prime brokerage benefits, stronger company franchise, economies of scale, etc.). The bank can generate significant new revenues from managing the customers' deposit accounts. The bank can use the league-based banking products as the foundations for new marketing platforms to cross-sell its existing portfolio of products and services to a whole new group of potential customers that was not already familiar with its products and services. Furthermore, the bank benefits from having the customers use its card technology as the customer identification tools for the indirect fund flow process. The bank increases its penetration among the fan base. In the age of one-stop financial shopping, the bank has a compelling edge in winning some of the consumer finance business, namely the debit card business, of these fans who up until that point might not have been its firm's customers. Finally, the bank can develop close relationships with the sponsors in the league, opening up potential advisory business with these sponsors going forward.

Fans and customers also share in the benefits. First, the leagues they follow and understand have a better chance of staying in existence due to their more financially-friendly method of sponsorship arrangements, as well as the increased ability for the league to raise capital to run and maintain the league. Second, fans can witness higher levels of competition in the league due to the fact that sponsors could be more willing to spend money on competitive participant campaigns now that greater direct monetary returns are possible. Fans also have the ability to participate in novel banking products. Furthermore, fans benefit from the fact they now have the ability to receive exclusive recognition for their brand loyalty. They can receive exclusive debit/ATM cards which have the logos of their favorite sponsors printed on them, and they can proudly carry around their cards knowing they have helped support the corporations which are funding the individual participants and the leagues they like. And finally, fans and all customers are able to benefit from the purchase incentives and pricing benefits that result from the league commerce network.

The invention has aspects of banking and also has aspects of insurance, investment, marketing, and consumer finance. In the discussion above, the invention is described using terms traditionally associated with banking and a banking process. That choice of terminology is selected because it is possible that the method and system will be treated by regulators as a banking process and a banking product. However, the fact that the concept and invention is described herein using the term banking does not limit the invention to a banking process if it is determined that the concept and invention is regulated as an investment product, a club, a membership plan, a benefits plan, an affinity-based product, a consumer card product, or some other marketing, sponsorship, or financial product.

In one embodiment, the banking process is linked to, or bundled with an investment product, and instead of labeling the product as a banking product with investment features, the customer might place funds into a brokerage account with banking features, or an investment account with banking features. In this type of wrap-account setup, in addition to receiving any or all of the features of the deposit account, as described in the invention, as well as in addition to receiving any or all of the features of the products and services which can be bundled with, or linked to a deposit account, as described in the invention, customer 102 may be able to receive investment brokerage services, such as the ability to invest or trade individual stocks, mutual funds, hedge funds, currencies, commodities, fixed-income securities, limited partnerships, exchange-traded securities, derivatives, hybrid securities, government securities, and any other investment vehicles which may be available to customers through investment accounts; customer 102 may also be able to receive financial advice, margin privileges, or any other services which may be bundled with, or included in an investment account. Customer 102 may be the person choosing the investment vehicles and managing the investment proceeds, or customer 102 may allow or have a financial advisor or investment manager choose the investment vehicles and manage his investment proceeds for him.

In another embodiment, the invention may be set up, or advertised, as a debit card, bank card, or ATM card arrangement, and any or all of these card functions may be linked to a deposit account of some sort.

In another embodiment, the deposit account is linked to, or bundled with one or more consumer card products which are not typically part of a deposit account. Consumer card products which are typically part of a deposit account are a debit card, an ATM card, or a combination debit/ATM card. Consumer card products which are not typically part of a deposit account include types of credit card, stored value, and prepaid card products, as well as all the other card services which have already been described as card privileges which can be bundled with the invention. In this embodiment where the invention is bundled with another consumer card product, the concept and invention may be set up and classified not as a deposit product, but rather as a separate type of card product with deposit banking features (where these banking features might not even be highlighted as key features of the product). For example, the deposit product may be bundled with a prepaid phone card (where the phone card is a stored value card) or an affinity program card (where the card serves as an ID card for the affinity program, and the card also may or may not have discounts pre-stored on the card). In these examples, customer 102 may deposit some form of equity, such as cash, cash equivalents, liquid securities, illiquid securities, and investment holdings with league sanctioning body 106, bank 104, another entity in system 100, or whatever company is offering these phone card (or affinity program) services. Customer 102 may place these funds with one or more of these entities as a refundable security deposit, as seed equity, or as some form of prepaid equity to open up a phone card account (or an affinity program account). Then, in addition to being able to use the phone card (or the affinity program card) for its intended benefits, customer 102 may also use the card to accrue benefits in the indirect fund flow process, and customer 102 may have the ability to place into deposit vehicles all or a portion of the up-front equity he deposited when joining the phone card product (or the affinity card product), the ability to place into deposit vehicles all or a portion of any follow-on equity generated from indirect fund flows, the ability to over time add additional funds to the phone card account or affinity program account (besides the up-front equity and the follow-on equity he has already placed or generated), the ability to place into deposit vehicles all or a portion of these additional funds he has added to the phone card account (or affinity program account) over time, and the ability to use any additional investment, consumer finance, or additional card privileges which are bundled with the phone card (or affinity program card) which customer 102 receives, or the phone card account (or affinity program account) which customer 102 has set up.

If the concept is run or regulated as a club, membership plan, affinity program, or benefits plan, the up-front fees for joining may not be classified as banking deposits, or direct fund flows as described in the invention, but rather as membership fees, club fees, or some type of similar fees for joining an affinity-based product. This classification may occur, even though the operator of the product is storing equity on behalf of customers in deposit vehicles, because the commerce network is the primary service rendered to customers, and the banking portion is a secondary service. It is further envisioned that if the invention is run or regulated as a club, membership plan, affinity program, or benefits plan, then in the invention, whatever sources of capital are referred to as indirect fund flows, these sources of capital may not be classified as banking deposits or other banking terms, but rather as membership, club, or affinity rewards or benefits, or some other terms which are non-banking related. Consequently, league sanctioning body 106, bank 104, or any other entity in system 100 who is running the membership, club, rewards, or affinity-based program may be the party, as opposed to customer 102, who is responsible for choosing the bank to manage the customers' funds, placing into deposit vehicles a portion or all of the up-front fees or dues paid when joining, placing into deposit vehicles a portion or all of the follow-on rewards received over time, and assuming the risks of making these banking-related actions and choices, where all these banking-related activities, actions, and choices may be a known or an unknown by-product of the customer's decision to join the club, membership program, benefits program, or affinity-based product.

The invention may also be set up so that customer 102 can join the banking process for free, with no up-front equity required, and once his account is open, start building up equity in the account by accumulating indirect fund flows from indirect sources. It is also possible that in the event system 100 or customer 102 chooses, customer 102 may not build up equity in his un-funded account, and customer 102 may simply use his account and system 100 as an instantaneous banking function, exchange mechanism, or aggregation function for converting the indirect fund flows he earns into immediate cash distributions. It is furthermore possible that customer 102 may pay a fee for joining the banking process, but because of how fees are calculated, customer 102 may not receive any starting equity in his account, and rather has to build up equity over time either through follow-on equity infusions (direct fund flows), or through equity he earns from indirect sources (indirect fund flows).

Although illustrative embodiments have been described herein in detail, it should be noted and will be appreciated by those skilled in the art that numerous variations may be made within the scope of this invention without departing from the principles of this invention and without sacrificing its chief advantages.

In the description above, it is envisioned that intermediaries may be involved. In particular, bank 104 might receive the funds directly from customer 102, or indirectly from an entity acting on behalf of customer 102, such as a financial advisor.

It is also envisioned that recipients of the post-banking pool value, the pre-banking pool value, or the pre-banking direct allocation may defer actual receipt of the value they are entitled to receive, with the value held for their accounts. A decision to have the value held on account might occur if fees are imposed on entities and these entities want the funds they earn to offset any fees they might be later required to pay.

Even if an entity is not actively trying to be a part of system 100, an entity becomes a default entity in system 100 if it offers incentives, grants opportunities for customer 102 to receive indirect fund flows, serves as an indirect source, provides indirect fund flows into the banking process, or serves a role in the embodiments related to the thresholds of activity and thresholds of performance.

In another embodiment, the card is not a traditional rectangular plastic card, but rather is a different shaped card, or some other device or instrument which customer 102 may use in place of a traditional plastic card to communicate account information. Examples of devices and instruments generally include cell phones, pagers, personal digital assistants, watches, laptops, portable music devices, and various other portable consumer electronic instruments which may communicate account information. It is envisioned that if a card is not used, and some other device or instrument is used to communicate account information, customer 102 may not actually receive a new device or instrument, but rather have his credit card information loaded into, saved on, or bundled into an existing device or instrument. In these instances where an instrument or device is used in place of a traditional plastic card, the corporate identifiers may be incorporated into the instruments and devices.

It is also envisioned that any entity receiving an allocation may receive the allocation as cash; a cash equivalent, such as an equity stake; or some non-cash equivalent, such as a service rendered or a product delivered in place of a cash allocation.

The term league sales medium/commerce network is intended to be a broad term, and examples include online networks, such as a portal; offline networks, such as purchase incentive programs in physical store locations; and loose networks of decentralized, isolated commerce transactions that are not aggregated in a central location before the funds reach the banking process as indirect flows. The commerce network may include any type of sales medium created between entities in the sports league. Any league entity may be either a seller or a buyer in the commerce network. This sales medium may consist of any transaction involving an indirect source; or it may consist of any opportunity, reward, or milestone which customer 102 attains and thus receives an indirect fund flow into the banking process. This sales medium may also consist of isolated commerce transactions which are already taking place independently of the banking process, and which now have incentives bundled with, or layered on top of them. The sales medium may also be so decentralized that system 100 only serves as a banking or financial aggregation function for the indirect fund flows, and thus the only time when two or more indirect sources may be able to be linked together is at step 802 when one or more entities in system 100 finally receives the indirect fund flows.

Although not specifically illustrated, it is also envisioned that steps may be combined from different figures, some steps may not be performed, and steps may be added.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

I claim:

1. A method for banking and sports league support, the method comprising:
receiving funds;
managing the funds for banking purposes;
determining a value of banking management activities;
determining a pool value;
providing the banking management value to a banking manager; and
providing the pool value to at least one entity in a sports league.

2. A method according to claim 1, further comprising providing the pool value from the managed funds.

3. A method according to claim 1, further comprising providing the pool value from the received funds.

4. A method according to claim 1, further comprising providing the banking management value from the managed funds.

5. A method according to claim 1, wherein receiving funds further comprises:
receiving funds from a customer.

6. A method according to claim 1, wherein receiving funds further comprises:
receiving funds from an indirect source.

7. A method according to claim 6, wherein the indirect source is related to a purchase decision in a sales medium/commerce network.

8. A method according to claim 6, wherein the indirect source is related to a threshold or milestone not related to a specific purchase transaction.

9. A method according to claim 1, wherein determining a pool value considers whether the managed funds satisfied banking objectives.

10. A method according to claim 1, wherein the at least one entity in a sports league is a league sanctioning body.

11. A method according to claim 1, wherein the at least one entity in a sports league is a league sponsor.

12. A method according to claim 1, wherein the at least one entity in a sports league is a participant sponsor.

13. A method according to claim 1, wherein the at least one entity in a sports league is a participant.

14. A method according to claim 1, wherein the at least one entity in a sports league is an indirect source.

15. A method according to claim 1, wherein the at least one entity in a sports league is a non-league related recipient.

16. A method according to claim 1, wherein the at least one entity in a sports league is a league owner.

17. A method according to claim 1, wherein the at least one entity in a sports league is a participant owner.

18. A method according to claim 1, wherein providing the pool value further comprises:
selecting at least one entity in a sports league; and
providing the pool value to the selected entity.

19. A method according to claim 18, wherein the funds are received from a customer and the customer selects the entity.

20. A method according to claim 1, wherein providing the pool value further comprises providing the pool value to a customer and at least one entity in a sports league.

21. A method according to claim 1, wherein providing the pool value further comprises providing the pool value to a banking manager and at least one entity in a sports league.

22. A system for banking and sports league support, the system comprising:
means for receiving funds;
means for managing the funds for banking purposes;
means for determining a value of banking management activities;
means for determining a pool value;
means for providing the banking management value to a banking manager; and
means for providing the pool value to at least one entity in a sports league.

23. Computer executable software code transmitted as an information signal, the code for banking and sports league support, the code comprising:
code to receive funds;
code to manage the funds for banking purposes;
code to determine a value of banking management activities;
code to determine a pool value;
code to provide the banking management value to a banking manager; and
code to provide the pool value to at least one entity in a sports league.

24. A computer-readable medium having computer executable software code stored thereon, the code for banking and sports league support, the code comprising:
code to receive funds;
code to manage the funds for banking purposes;
code to determine a value of banking management activities;
code to determine a pool value;
code to provide the banking management value to a banking manager; and
code to provide the pool value to at least one entity in a sports league.

25. A programmed computer for banking and sports league support, comprising:
a memory having at least one region for storing computer executable program code; and
a processor for executing the program code stored in the memory; wherein the program code comprises:
code to receive funds;
code to manage the funds for banking purposes;
code to determine a value of banking management activities;
code to determine a pool value;
code to provide the banking management value to a banking manager; and
code to provide the pool value to at least one entity in a sports league.
